(19) United States
(12) Patent Application Publication
(10) Pub. No.: US 2022/0056696 A1
(43) Pub. Date: Feb. 24, 2022

(54) LIQUID APPLIED ROOFING COMPOSITE

(71) Applicant: Milliken & Company, Spartanburg, SC (US)

(72) Inventors: Robert D. Miller, Piedmont, SC (US); Yunzhang Wang, Duncan, SC (US); Randolph S. Kohlman, Boiling Springs, SC (US); David W. Martin, Moore, SC (US); Manuel Ramirez, Simpsonville, SC (US)

(21) Appl. No.: 17/380,780

(22) Filed: Jul. 20, 2021

Related U.S. Application Data
(60) Provisional application No. 63/067,104, filed on Aug. 18, 2020.

(51) Int. Cl. E04D 5/10

(52) U.S. Cl. CPC E04D 5/10

(57) ABSTRACT

The invention relates to a liquid applied roofing membrane which contains a textile with a compatibility coating covering essentially all of the fibers of the textile forming a coated textile, a first membrane, and a second membrane. The textile contains a plurality of yarns, the yarns comprising a plurality of fibers. The compatibility coating has a weight of between about 0.5 and 10% of the weight of the textile and contains a first chemistry. The first membrane contains a second chemistry and is located on the first side of the textile, forms the lower surface of the roofing membrane, and covers at least a majority of the second side of the textile. The second membrane contains a third chemistry and is located on the second side of the textile. The first, second, and third chemistries comprise the same class of polymeric material.

### RELATED APPLICATIONS

This application is a continuation of co-pending U.S. Provisional Patent Application 63/067,104, filed on Aug. 18, 2020, which is incorporated herein by reference in its entirety.

### TECHNICAL FIELD

The present invention relates generally to liquid applied roofing composites, more particularly to liquid applied roofing composites containing a textile with a compatibility coating.

### BACKGROUND

It is known to use liquid applied roofing membranes for roofing applications, especially where there is no to low sloped roofs. A textile may be embedded into the membrane for beneficial physical properties. It is desirable to have an improved textile for the roofing system.

### BRIEF SUMMARY OF THE INVENTION

The invention relates to a liquid applied roofing membrane which contains a textile with a compatibility coating covering essentially all of the fibers of the textile forming a coated textile, a first membrane, and a second membrane. The textile contains a plurality of yarns, the yarns comprising a plurality of fibers. The compatibility coating has a weight of between about 0.5 and 10% of the weight of the textile and contains a first chemistry. The first membrane contains a second chemistry and is located on the first side of the textile, forms the lower surface of the roofing membrane, and covers at least a majority of the second side of the textile. The second membrane contains a third chemistry and is located on the second side of the textile. The second membrane forms the upper surface of the roofing membrane. The first, second, and third chemistries comprise the same class of polymeric material.

### BRIEF DESCRIPTION OF THE DRAWINGS

The present invention is best understood with reference to the following detailed description of embodiments of the invention when read in conjunction with the attached drawings, in which like numerals refer to like elements, and in which:

FIG. 1 shows cross-sectional illustration of one embodiment of the liquid applied roofing membrane.

FIG. 2 shows cross-sectional illustration of another embodiment of the liquid applied roofing membrane where the textile is fully embedded into the first membrane.

### DETAILED DESCRIPTION

The present invention generally relates to liquid applied roofing membranes and improved coated textiles that are embedded in and strengthen the membrane. In some embodiments, the liquid applied roofing membrane is designed to meet or exceed several FR testing protocols common in the roofing industry.

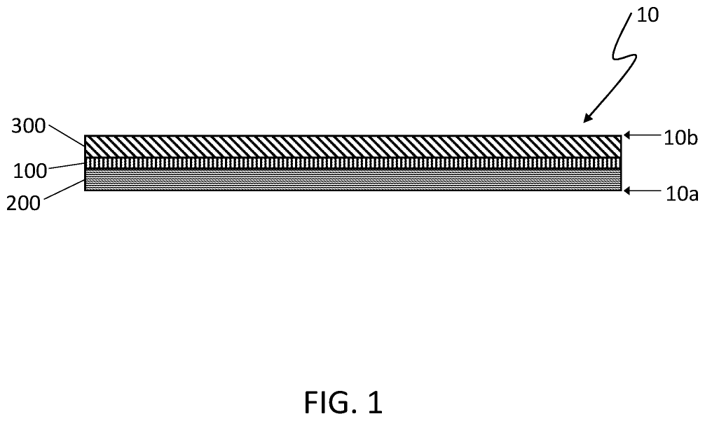

Referring now to FIG. 1, there is shown a cross-sectional illustration of one embodiment of the liquid applied roofing membrane 10 having an upper surface 10b and a lower surface 10a. The liquid applied roofing composite 10 contains a textile 100 having a first side and a second side. The textile 100 contains a plurality of yarns and the plurality of yarns contain a plurality of fibers. There is a compatibility coating covering at least a portion of the yarns in the textile which forms a coated textile. This has also been referred to as a capability coating in previous applications and in these applications, compatibility coating and capability coating mean the same thing. The compatibility coating has a weight of between about 0.5 and 10% of the weight of the textile 100 and the compatibility coating comprises a first chemistry.

The liquid applied roofing membrane 10 also contains a first membrane 200 and a second membrane 300. The first membrane 200 contains a second chemistry, is located on with the first side of the textile 100 and forms the lower surface 10a of the roofing membrane 10. The second membrane 300 contains a third chemistry, is located on the second side of the textile, and forms the upper surface 10b of the roofing membrane 10.

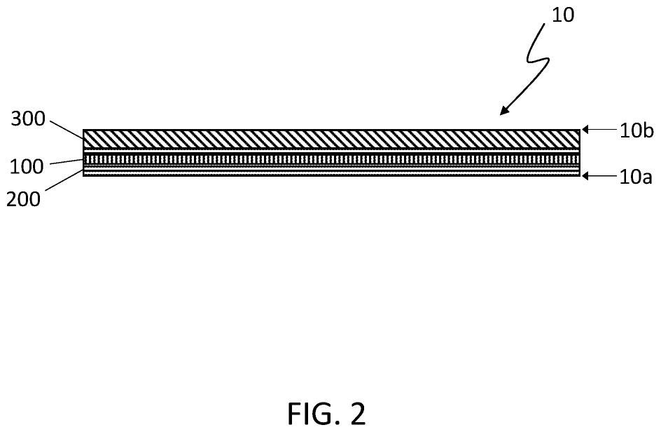

In one embodiment, as shown in FIG. 1, the textile 100 is located between the first membrane 200 and the second membrane 300. In another embodiment, the textile 100 is at least partially embedded in the first membrane 200 and/or the second membrane 300. In another embodiment, such as shown in FIG. 2, the textile 100 is fully embedded into the first membrane 200 or the second membrane 300.

The textile 100 may be any suitable textile depending on the end product and desired properties of the end product. The construction, yarns, materials, and other factors can contribute to the characteristics of the textile 100 and the liquid applied roofing membrane 10.

In one embodiment, the textile 100 may be any suitable knit textile, for example a circular knit, reverse plaited circular knit, double knit, single jersey knit, two-end fleece knit, three-end fleece knit, terry knit or double loop knit, weft inserted warp knit, warp knit, and warp knit.

In one embodiment, the knit textile is a circular knit textile. In a preferred embodiment, the circular knit textile is a double knit textile. It has been found that double knit textiles have good stretch and recovery properties and also low curling. A circular knit textile would typically have an areal weight of between about 3 and 6 oz/yd². Circular knits have a number of characteristics that make them suitable for membrane applications. Circular knit textiles tend to have high stability, the interconnected loops transfer load while minimizing yarns slipping. Circular knit textiles tend to not curl, and many constructions do not have a sidedness (no right or wrong side to the fabric). Circular knit textiles have a tendency to create good cover per weight, demonstrate high elongation (50-80% in machine direction), (80-180% in the cross machine direction), and are flexible with changes in elevation/roof deformities. This flexibility allows for the knit textile to be “distorted” or “contorted” to fit around the roof details (fit around flashing) & penetrations without elastic recovery during the installation process. Circular knit textiles can be designed to have the right combination of openness to allow penetration of liquid applied base coating, but still provide the necessary cover to bridge gaps and roof elevation changes.

In another embodiment, the knit textile is a warp knit textile which can be any suitable warp knit textile. In one preferred embodiment, the warp knit textile is in a tricot stitch pattern. In one embodiment, the warp knit textile consists of a set of laid in warp yarns, a set of laid in weft yarns, and a set of stitching yarns. In this embodiment, the warp yarns and the weft yarns are not interwoven but are laid on top of one another and the stitching yarns use stitches to connect the warp and weft yarns together. “Consists of”, in this application means “only contains”. Therefore, this embodiment contains 3 set of yarns (laid in warp, laid in weft, and stitching) and precludes any embodiment with different sets of yarns. In another embodiment, the warp knit textile consists of a set of laid in weft yarns and a set of stitching yarns. In this embodiment, the knit textile would not contain a set of warp yarns. In these two embodiments described above, the stitching yarns are in one embodiment a thicker yarn than what is typically used.

In one embodiment, the stitching yarns have a denier of at least about 150 denier, more preferably greater than about 200 denier. A warp knit textile would typically have an areal weight of between about 2 and 6 oz/yd². A warp knit allows the introduction of a set of straight warp yarns and/or a set of straight weft yarns which allow the mechanical properties to reflect the yarn properties which typically leads to stiffer fabrics. One benefit of a warp knit textile is that the warp and weft direction mechanical properties can be more independently tailored. The fabric is able to be designed to control tensile in both directions and demonstrate the elongation of the designed yarn. Warp knit textiles may be designed to have the right combination of openness to allow penetration of liquid applied base coating, but still provide the necessary cover (due to the tricot stitch) to bridge gaps and roof elevation changes.

Knit textiles are generally preferred because of their stretch and recovery allowing easier application to roofs including parapets and other elements that may be in the roof area where the membrane is being installed. In one embodiment, at least about 60% by number of the fibers are within 45 degrees of the plane formed by the membrane, more preferably at least about 75% by number. This means that most of the fibers are laying in the plane of the membrane instead of a more perpendicular orientation to it. When fabrics such as nonwovens are used in a liquid applied roofing membrane, the fibers are at many random angles including angles approaching perpendicular to the plane of the roofing membrane. These more perpendicular fibers have a tendency to stick out of the roofing membrane which allows for a path for water to travel through the membrane and reach the roof below. In some cases, these more perpendicular fibers must be removed (by buffing, sanding, and the like) and then in some cases, an additional membrane might need to be applied.

In one embodiment, the textile is a woven textile. The weave may be, for example, plain, satin, twill, basket-weave, poplin, jacquard, and crepe weaves. Preferably, the woven textile is a plain weave textile. It has been shown that a plain weave has good abrasion and wear characteristics. A twill weave has been shown to have good properties for compound curves so may also be preferred for some roofing applications.

In another embodiment, the textile is a nonwoven. The term nonwoven refers to structures incorporating a mass of yarns that are entangled and/or heat fused so as to provide a coordinated structure with a degree of internal coherency. Nonwoven textiles may be formed from many processes such as for example, meltspun processes, hydroentangeling processes, mechanically entangled processes, stitch-bonded and the like. In another embodiment, the textile is a unidirectional textile and may have overlapping yarns or may have gaps between the yarns. In another embodiment, the nonwoven may contain warp and/or weft yarns stitched, embedded, adhered or otherwise attached to the nonwoven fibers.

A compatibility coating covers at least a portion of the yarns in the textile 100. In one embodiment, the coating is applied using a dip-type method where the textile is immersed into the coating while the coating is liquid. This allows the coating to coat essentially all of the surface area of the yarns. “Essentially all” in this use means that at least 95% of the surface area of the yarns in the textile are coated. In some embodiments, the coating enters the yarns and coats at least a portion of the fibers within the yarns. In one embodiment essentially all of the surface area of the fibers are coated with the compatibility coating. When the textile 100 is coated with the compatibility coating, it is referred to herein as the coated textile. This compatibility coating serves to better bond the textile 100 to the first and the second membranes 200, 300, gives an amount of rigidity to the textile 100 so that it can more easily be handled and installed, and allow for the easier and quicker wet out of the textile 100 by the membranes 200, 300 which are applied as a liquid.

The compatibility coating contains a first chemistry. Because the goal is for the compatibility coating to help better adhere and wet out with the membranes, the first chemistry preferably contains the same class of polymeric material as the second chemistry and the third chemistry (which the first and second membranes 200, 300 contain, respectively). “Same class of polymeric material”, in this application, means that the two polymeric materials share a common backbone unit in the backbone of the polymeric material (they can have additional backbone units not common to both materials or branches also not common to both materials). Preferably, the first, second, and third chemistries contain almost exclusively polyurethane polymers or pre-polymer segments covalently linked by carbamate and/or urea functional groups. Polyurethanes are a versatile class of materials. They have broad applications in numerous industries, such as foam and cushions, automotive interiors, films, floorcovering, etc. In this specific application the polyurethane polymers have high elongation and tensile strength, ideal properties for a roofing membrane. These class of materials are classically formed by the reaction of multifunctional isocyanates with polyhydritic alcohols. However, the reaction kinetic, polymeric architecture, and physical properties are all highly tunable through nuanced control of the system.

There are manifold reasons for choosing this class of material for the compatibility coating. Firstly, it imbues the textile with a desirable modulus/stiffness. These characteristics help the textile lay down compliantly into the liquid application of the first membrane and minimizes wrinkling. These are features that simplify installation and reduces reworking, ultimately reducing time up on a roof. Secondly, matching the class of material for the compatibility coating to that of the second and third chemistry of the membranes, in this case polyurethane, facilitates a rapid and more complete wetting of the textile in the liquid application of the first and second membranes. This enhanced interaction maximizes the bonding of the textile with each membrane at their respective interfaces to give a stronger composite.

In another embodiment, the first, second, and third chemistries comprise polyacrylate. In another embodiment, the first, second, and third chemistries comprise polymethyl-methacrylate. In another embodiment, the first, second, and third chemistries comprise bitumen. In one preferred embodiment, the second and third chemistries comprise the same material, more preferably they consist of the same material (meaning that the second and third chemistries are exactly the same).

The compatibility coating has a weight of between about 0.5 and 10% of the weight of the textile 100, more preferably between about 1.5 and 3.5% of the weight of the textile 100.

In the embodiments where the first chemistry is a polymer, the polymer preferably has a high 100% modulus and a low elongation at break. Preferably the 100% modulus is higher than about 5 MPa, more preferably higher than about 10 MPa, even more preferably higher than about 20 MPa. The elongation at break is preferably less than about 500%, more preferably less than about 250%, even more preferably less than about 200%, even more preferably less than about 150%. The 100% modulus and elongation at break are typically tested according to ASTM D412. The high 100% modulus and low elongation at break properties of the polymer allow the coated knit fabric to stiffen up, providing more dimensional stability and having a lower propensity to wrinkle, and thus easier to apply and work into second chemistry.

The yarns making up the textile 100 may be any suitable yarn. “Yarn”, in this application, as used herein includes a monofilament elongated body, a multifilament elongated body, ribbon, strip, fiber, tape, and the like. The term yarn includes a plurality of any one or combination of the above. The yarns may be of any suitable form such as spun staple yarn, monofilament, or multifilament, single component, bi-component, or multi-component, continuous filament and have any suitable cross-section shape such as circular, multi-lobal, square or rectangular (tape), and oval. Most of the yarns described contain fibers (and some of the embodiments described above as yarns may also be described as fibers).

In one embodiment, at least a portion of the yarns of the textile 100 contain polyester fibers. In one embodiment, the textile 100 contains at least about 40% by weight, more preferably at least about 50% by weight, more preferably at least about 70% by weight polyester fibers. In another embodiment, the textile 100 contains at least about 90% by weight, more preferably at least about 95% by weight. In one embodiment, the textile comprises essentially all polyester fibers, defined as being at least 98% by weight of the total textile.

The textile 100 can be formed from a single plurality or type of yarn (e.g., the fabric can be formed solely from polyester yarns), or the textile can be formed from several pluralities or different types of yarns (e.g., the fabric can be formed from a first plurality of polyester yarns a second plurality of aramid yarns).

In some embodiments, it may be necessary for the finished liquid applied roofing membrane to have some fire resistance (FR) characteristics. One way to tailor the FR properties is through the addition of FR fibers and/or yarns. These FR yarns can contain just FR fibers, or blends of FR and other fibers. As utilized herein, the term “inherent flame resistant fibers” refers to synthetic fibers which, due to the chemical composition of the material from which they are made, exhibit flame resistance without the need for an additional flame retardant treatment. In such embodiments, the inherent flame resistant fibers can be any suitable inherent flame resistant fibers, such as polyoxadiazole fibers, polysulfonamide fibers, poly(benzimidazole) fibers, poly(phenylenesulfide) fibers, meta-aramid fibers, para-aramid fibers, polypyridobisimidazole fibers, fiberglass fibers, basalt fibers, fiberglass wrapped with polyester fibers, polybenzylthiazole fibers, polybenzyloxazole fibers, melamine-formaldehyde polymer fibers, phenol-formaldehyde polymer fibers, oxidized polyacrylonitrile fibers, polyamide-imide fibers and combinations, mixtures, or blends thereof. In certain embodiments, the inherent flame resistant fibers are preferably selected from the group consisting of polyoxadiazole fibers, polysulfonamide fibers, poly(benzimidazole) fibers, poly(phenylenesulfide) fibers, meta-aramid fibers, para-aramid fibers, and combinations, mixtures, or blends thereof. Fibers that are treated to have FR properties such as FR cellulose may also be used.

The flame resistant fibers can be present in the textile in any suitable amount. Generally, the amount of inherent flame resistant fibers included in the textile will depend upon the desired properties of the final textile. In certain embodiments, the inherent flame resistant fibers can comprise about 50% or less, about 40% or less, about 30% or less, about 25% or less, about 15% or less, or about 10% or less, by weight, of the fibers present in the textile. In certain embodiments, the flame resistant fibers can comprise about 1% to about 50%, about 5% to about 40%, about 10% to about 30, by weight, of the fibers present in the textile.

The liquid applied roofing composite 10 is preferably attached to a roof deck or built-up roof deck (or other structure). First, the first membrane is applied to a prepared roof (which can have insulation, evening layers, plywood, or even another roofing membrane) in a liquid state. While the first membrane is still in liquid form, the coated textile is laid down onto the first membrane. The coated textile may wet out on its own or may need additional mechanical forces to push the coated textile into the first membrane. After the first membrane is solidified (at least partially cured), the second membrane is applied on top of the partially cured first membrane and the whole system is cured into the liquid applied roofing membrane. Additional layers may optionally be applied on top of the membrane 10 for additional sun reflection, abrasion resistance, or other properties.

A roof deck is generally described as a construction member or system comprising one or more essentially planar elements of, but not limited to steel, aluminum, concrete, wood, gypsum, composites, or other rigid or semi-rigid materials and which may form or rest upon one or more structural construction members, and which serves either as a complete roofing system or, more typically, as a base onto which additional roofing elements are added or built up.

### EXAMPLES

The following test methods were used to test the fabric examples. Weight testing was described by ASTM D3776; Thickness testing was described by ASTM D1777; Air permeability testing was described by ASTM D737; and Grab tensile testing was described by ASTM D5034. Fabric Stiffness was calculated from the Grab Tensile loading curve as the value of the load at 0.1 inch strain divided by 0.1 inch of strain. It was an estimate of the initial slope of the stress/strain curve.

### Example 1

A polyester double-knit fabric was produced on a 30″ diameter machine. 100 denier yarns were arranged as Dial and Cylinder on a 16 needle repeat rib-twill design. The fabric was knitted with 30 courses per inch alternating 3/1 Cylinder-Dial for a 1½ Dial late and 24 Wales per inch.

The fabric was coated with an anionic polyurethane dispersion using a padding (dip/nip) process. The polyurethane chemistry was a polycarbonate polyurethane. It contained approximately 35% non-volatile content and had a pH value of 8.5. The dried film of the polyurethane had a 100% modulus value of 20-25 MPa and elongation at break value of 150-200%.

To apply the coating, the fabric was first immersed in a chemical bath containing a 10% aqueous dilution by weight of the polyurethane dispersion. After fully saturated, the fabric was then passed through a set of squeeze rolls at 40 psi pressure and then dried in a forced air oven at 380 to 410° F. under tension and support from tenter chains. The wet pickup of the polyurethane dispersion was approximately 70%. The following measurements were obtained for the fabric:
a. Weight: 3.45 oz/yd²
b. Thickness: 20.4 mils
c. Air Perm @125 Pa: 450 cfm
d. Grab Tensile
   i. Machine Direction: Peak Load: 86.6 Lb; Elongation at peak load: 55.9%; Stiffness: ˜33.8 Lb/in
   ii. Cross-Machine Direction: Peak Load: 59.5 Lb; Elongation at peak load: 124.5%; Stiffness: ˜25.9 Lb/in

### Example 2

A polyester double-knit fabric was produced on a 30″ diameter machine. 200 denier yarns were arranged as Dial and Cylinder on a repeat rib-twill design. The fabric was knitted with 30 courses per inch alternating Cylinder-Dial for a 1½ Dial late and 24 Wales per inch.

The fabric was coated with an anionic polyurethane dispersion using a padding (dip/nip) process. The polyurethane chemistry was a fire-retardant urethane co-polymer with a stiff hand. It contained approximately 36% non-volatile content and had a pH value of 7.0.

To apply the coating, the fabric was first immersed in a chemical bath containing a 10% aqueous dilution by weight of the polyurethane dispersion. After fully saturated, the fabric was then passed through a set of squeeze rolls at 40 psi pressure and then dried in a forced air oven at 380 to 410° F. under tension and support from tenter chains. The wet pickup of the polyurethane dispersion was approximately 70%. The following measurements were obtained for the fabric:
a. Weight: 5.7 oz/yd2
b. Thickness: 21.5 mils
c. Air Perm 720 cfm
d. Grab Tensile
   i. Machine Direction: Peak Load: 148.8 Lb; Elongation at peak load: 33.1%; Stiffness: ˜56 Lb/in
   ii. Cross-Machine Direction: Peak Load: 73.2 Lb; Elongation at peak load: 165.7%; Stiffness: ˜20 Lb/in

### Example 3

A weft-insertion, warp-knit fabric was produced on a Raschel warp-knitting machine. Stitch yarns are a 2-ply 100 denier textured polyester, forming a tricot stitch at a density of 22 stitches per inch. Weft construction density was 22 per inch; with a 2-ply 150 denier textured polyester designed to have specific strength and stretch properties.

The fabric was coated with an anionic polyurethane dispersion using a padding (dip/nip) process. The polyurethane chemistry was a fire-retardant urethane co-polymer with a stiff hand. It contained approximately 36% non-volatile content and had a pH value of 7.0.

To apply the coating, the fabric was first immersed in a chemical bath containing a 10% aqueous dilution by weight of the polyurethane dispersion. After fully saturated, the fabric was then passed through a set of squeeze rolls at 40 psi pressure and then dried in a forced air oven at 380 to 410° F. under tension and support from tenter chains. The wet pickup of the polyurethane dispersion was approximately 70%. The following measurements were obtained for the fabric:
a. Weight: 3.45 oz/yd²
b. Thickness: 16.3 mils
c. Air Perm @ 125 Pa: 1000 cfm
d. Grab Tensile
   i. Machine Direction: Peak Load: 96.5 Lb; Elongation at peak load: 21.5%; Stiffness: ˜114.6 Lb/in
   ii. Cross Machine Direction: Peak Load: 87.4 Lb; Elongation at peak load: 36.6%; Stiffness: ˜50.4 Lb/in

Each of the example textiles above could be used in liquid applied roofing membranes and it is believed the coated textiles of the examples would perform well in a liquid applied roofing membrane.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A liquid applied roofing membrane having an upper surface and a lower surface, wherein the membrane comprises:
a textile having a first side and a second side, wherein the textile comprises a plurality of yarns,
a compatibility coating covering at least a portion of the surface area of the yarns of the textile forming a coated textile, wherein the compatibility coating has a weight of between about 0.5 and 10% of the weight of the textile, and wherein the compatibility coating comprises a first chemistry;
a first membrane comprising a second chemistry, wherein the first membrane is located on the first side of the textile, wherein the first membrane forms the lower surface of the roofing membrane and covers at least a majority of the second side of the textile; and,
a second membrane comprising a third chemistry, wherein the second membrane is located on the second side of the textile, wherein the second membrane forms the upper surface of the roofing membrane, and wherein the first, second, and third chemistries comprise the same class of polymeric material.

2. The liquid applied roofing membrane of claim 1, wherein the textile is a knit textile.

3. The liquid applied roofing membrane of claim 2, wherein the knit textile is a circular knit textile.

4. The liquid applied roofing membrane of claim 2, wherein the knit textile is a warp knit textile having a tricot stitch pattern.

5. The liquid applied roofing membrane of claim 2, wherein the knit textile is a warp knit textile consisting of a set of laid in warp yarns, a set of laid in weft yarns, and a set of stitching yarns.

6. The liquid applied roofing membrane of claim 2, wherein the knit textile is a warp knit textile consisting of a set of laid in weft yarns and a set of stitching yarns.

7. The liquid applied roofing membrane of claim 1, wherein the textile is a woven textile.

8. The liquid applied roofing membrane of claim 1, wherein the textile is at least partially embedded into the first membrane.

9. The liquid applied roofing membrane of claim 1, wherein the textile is fully embedded into the first membrane.

10. The liquid applied roofing membrane of claim 1, wherein the textile is fully embedded into the second membrane.

11. The liquid applied roofing membrane of claim 1, wherein the first chemistry comprises a first polyurethane polymer having a 100% modulus of at least about 5 MPa.

12. The liquid applied roofing membrane of claim 1, wherein the first chemistry comprises a first polyurethane polymer having an elongation of less than about 500%.

13. The liquid applied roofing membrane of claim 1, wherein the compatibility coating has a weight of between about 1.5 and 3.5% of the weight of the textile.

14. The liquid applied roofing membrane of claim 1, wherein the first, second, and third chemistries comprise a polymer.

15. The liquid applied roofing membrane of claim 14, wherein the first, second, and third chemistries comprise a polyurethane.

16. The liquid applied roofing membrane of claim 14, wherein the first, second, and third chemistries comprise a polymethyl-methacrylate polymer.

17. The liquid applied roofing membrane of claim 14, wherein the second chemistry and the third chemistry comprise bitumen.

18. The liquid applied roofing membrane of claim 14, wherein the second chemistry and the third chemistry consist of the same material.

19. The liquid applied roofing membrane of claim 1, wherein at least 90% by weight of the fibers of the textile comprise polyester.

20. The liquid applied roofing membrane of claim 1, wherein the plurality of yarns comprises a plurality of fibers.
